(19) United States
(12) Patent Application Publication
(10) Pub. No.: US 2015/0278963 A1
(43) Pub. Date: Oct. 1, 2015

(54) Electronic trading cards and method of use

(71) Applicants: Kendall R. Nishimine, San Francisco, CA (US); Thomas J. Marbois, Columbus, GA (US); Brian C. Wilson, Portland, OR (US)

(72) Inventors: Kendall R. Nishimine, San Francisco, CA (US); Thomas J. Marbois, Columbus, GA (US); Brian C. Wilson, Portland, OR (US)

(21) Appl. No.: 14/671,275

(22) Filed: Mar. 27, 2015

Related U.S. Application Data
(60) Provisional application No. 61/971,734, filed on Mar. 28, 2014.

(51) Int. Cl. G06Q 50/00; H04L 29/08; H04W 4/02; G06Q 30/02

(52) U.S. Cl. CPC G06Q 50/01; G06Q 30/0222; H04L 67/1095; H04L 67/18; H04W 4/023

(57) ABSTRACT

An electronic trading card is disclosed. The trading card can operate using all the convention social media platforms, and allows for a more personal interaction between celebrities and their fans. The cards can have one or more images, with additional images being available for purchase, through trading, or given away by the star for free or as rewards for fan loyalty. Through the cards, fans and celebrities can exchange messages and videos, and celebrities can allow a fan to follow their daily routine to a greater or lesser extent. Third parties can analyze the data from the star/fan interactions and advise the star on managing his/her public image, and allowing merchandisers to more accurately target their advertising and promotional campaigns.

### CROSS REFERENCE TO RELATED APPLICATIONS

This application claims the benefit of U.S. Prov. Pat. App. No. 61/971,734 filed on Mar. 28, 2014, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general fields of trading cards and collectible items related to stars, both human celebrities and notable teams/products/cities, etc., and more specifically toward an electronic “trading card” that can be used to convey messages between stars and fans, and to provide data useful to both the star interested in creating a certain image to his/her/its fans, and retailers interested in targeting the star's fans. To this end, an electronic trading card is provided which can be created and issued by stars to their fans, and through which the star and fan can interact, and which, like a traditional trading card, can be collected, traded or shared.

The idea of trading cards originated in the 1800's, with the earliest baseball trading cards being produced in the 1860's. By the early 1900's, baseball, soccer and basketball trading cards were established industries. By the 1950's, the idea of trading cards had become established in many different circles, including TV shows, professional football, and even big game hunting. By the turn of the century, there were trading cards for just about every sport, game, event and prestigious profession in the US. In 2000, the first electronic digital counterpart of a trading card was sold, where the actual card remained in a climate controlled vault but it was “owned” by a person who initially purchased it could sell it to other people.

The trading card industry, however, has been in decline for over 20 years. From its peak in 1991, when it recorded $1.1 billion in sales, sales have steadily declined. This has been blamed on everything from arrogant athletes and strikes to computers and video games. Regardless of the reason (or reasons), the fact remains that traditional trading cards are no longer an effective way to reach the younger generations. Any visit to a baseball trading card convention will highlight the fact that most trading card enthusiasts are middle-aged (or older) men who did not grow up with computers.

Thus there has existed a long-felt need for a revitalized approach to trading cards that will not only appeal to the younger generations, but will also provide the personal data that is so highly valued in today's internet retail market.

### SUMMARY OF THE INVENTION

The current invention provides just such a solution by having a virtual trading card that exists only in an electronic format. The trading card can be bought, sold, traded, or even given away. The card is basically an electronic file that a consumer downloads, and shows one or more images of the star. Again, the “star” can be a human celebrity, a famous animal such as “Herman the Sturgeon” or “Shamu”, a sports team, a city, even a favorite national park. As opposed to a traditional trading card that has only two sides, the digital card can have an unlimited number of “sides”. The functions can include, but are not limited to:

A cover, one or more “backs” or “sides” to the card, with or without moving and/or interactive graphics, and may include window to card/star/user data (info panel); the possibility that the card could be electronically dated to expire or be products as a “limited edition”; connections to news/social network feeds, direct connect to outside systems and data, Blipback video comment platform and video blogging; a moderation feature allows star to control focus of videos and allows direct video communication between stars and fans by which fans can leave text, photo or video messages for the star and the star can respond selectively to one or more videos; crowd-unlock and other functions/features/incentives can be unlocked when multiple users are in one or more of the following situations: in close proximity to other card holders, a specific location, or even the star, are acting collectively with other card holders; abilities of various card holders to share cards/information and get points, add value to individual cards and/or user account, including points (in-app monetary system) and other reward functions; allow for a user account, and, optionally, individual cards.

Each side can, optionally, have a separate function, or contain multiple functions. There may be additional star images that the user can download in the future for additional payment, as part of a promotional campaign, or for free over selected periods of time as a reward for “fan loyalty ”. The star can also release more than one card, such that a user could try to collect all of that star's cards.

The cards can also gain “powers” through winning special contests the star puts on, through trading, or through other uses. These same types of contests or other activities can be used to “unlock” additional features of the card and make it more useful to the owner, valuable as a collector's item, and desirable for trading or sharing.

Some cards can additionally be made in a “limited edition” where there are finite numbers of each card, and the cards can optionally be numbered, for example, 43/200, such that owner of the card realizes and only 200 of these cards have been made and he/she is the owner of card #43 in that lot. Optionally, limited, as well as unlimited cards, can “expire” if they are not used. Optionally, “expiration” can also be tied to other events, such as failure to be traded by a certain deadline or other events.

Cards can also be used to unlock real-world events and services. For example, should a fan get to a certain level, he/she could gain instant access to a star's concert. This access could be directly from within the app, perhaps by giving the user a visual code that can be scanned at the event entrance to allow entry. The “rewards” could also be discounts on products, services or events, or could be combined with other cards, or as a group with other card holders working cooperatively, for special rewards.

Cards could be made with some sort of GPS built into them to facilitate geo-awareness for the user and for that particular user's social media.

It is also contemplated that a “white label” version of the cards could be produced that would allow anyone with a white label card to make their own electronic cards. This could allow people to pay homage to everything from their favorite singers and actors to their children and dogs. There could be a dashboard backend to make the process simple, and additional perks could be won through any of the other “leveling opportunities” discussed in this application.

The user/fan can also use the card to contact the person on the card. For example, the fan can send the star a message, or post a video on the star's page. The star can selectively view and answer these posts (or pay staffers to do in for him or her), but in any case, fans feel as though they have an actual chance to have the star see their posts and perhaps respond directly to them.

The star could also try to garner more attention or have the fans play a more active role in his/her following by arranging for games, or location-based activities that would unlock certain special access, passwords, and/or additional rewards such as additional images of the star or even “grand prizes” such as the star recording an outgoing message for the fan's cell phone.

The electronic trading card could be integrated into existing social network platforms, such that the fan and the star could selectively choose which of the existing and future social media platforms would host their posts. The fan posts could also be analyzed to provide fan-base metrics to the star and retail organizations.

Additional characteristics of the cards include means by which the value of the cards can increase over time. First, this could be done by providing a limited number of certain cards (by way of example, the most valuable trading card in the world appears to be the Honus Wagner T206 card of which very few exist today, that we recently sold for nearly $3,000,000). Second, the card could “degrade” over time or even “expire” in their ability to be traded to other fans. Third, there could be puzzles or other games where it would take a collaborative effort by a number of fans with cards to achieve the reward.

Fourth, the card could be tied into the biometrics of the actual star, so a fan could see whether the star is walking, what his/her heart rate and other personal data is, even his or her weight. Just imagine the fan/star interaction that could be possible if a famous actress ate a lot of dinner one night and her “card” would show that her weight jumped three pounds. Then, many of her fans posted through their cards messages about not getting fat, or what type of exercise they think she should do. She could then pick one of the exercises suggested by the fans and reward the “wining” fans with another image or other reward. She could even poll her fans about whether she should have desert or not, and what kind of desert she should have.

A similar interaction could be achieved with sports celebrities, ranging from real-time monitoring of their biometrics during a game to having the star's biometrics feed into the fan's personal fantasy sports team. The star athlete could even participate in participating in replays of key fantasy sports plays.

It is an object of the invention to provide an electronic trading card with a value to both the fan and the star.

Additional objects of the invention include:

Allowing fans and celebrities to interact with each other through the ability to post messages and videos through the card.

Allowing fans to share, trade, and sell their cards.

Allowing fans to increase their access to a star by “leveling up”, collecting more badges or other rewards.

Allowing celebrities to increase their fan base through giving out cards, allowing current users to “double” their cards and give one away, or other means.

Allowing celebrities to quickly view and assess the messages coming in from fans, and use that data to manage their image to their fans.

Allowing celebrities to selectively respond to certain messages from fans.

Allowing celebrities to more readily mobilize their fans to attend or participate in events, such as concerts, new records being available for purchase, social events, fan events, sports events, etc.

Allowing for the capture of fan-base metrics which can later be used by the star to manage his/her public image and self-promotional campaign, and by retail operations which want to capitalize on a particular star's fans.

Allowing for means by which celebrities are notified when a fan leaves a message and fans are notified when celebrities leave a message on his/her card.

Allowing for third parties to analyze the data from these interactions and 1) assist the star in uncovering potential fan bases, 2) assist merchandisers in targeting their advertisements, and 3) craft unique experiences with the celebrities that in increase fan involvement and advertising dollars.

It is a further object of this invention to provide a means by which sponsors and celebrities can more accurately gauge what a reasonable sponsorship package would include, based on the fan-base metrics and interactions that have all been digitally recorded and can be computer analyzed.

A particular embodiment of the current disclosure is an electronic trading card system comprising a server system comprising memory, a processor, and one or more software programs, where the software programs are stored within the memory and are executed by the processor, and where the software programs include instructions for: storing an electronic trading card, where the electronic trading card comprises a plurality of virtual sides, a digital image, and text data, where the digital image is associated with at least one of the plurality of virtual sides, where the text data is associated with at least one of the plurality of virtual sides; transmitting the electronic trading card to a first client system; receiving a data request from the first client system; and transmitting the data request to a second client system, where the second client system is associated with an entity that is a subject of the electronic trading card. The electronic trading card further comprises one or more hidden virtual sides, where each of the one or more hidden virtual sides comprises digital image content, text content, or both. The software programs further include instructions for transmitting the electronic trading card to a third client system; receiving an unlock request from the first client system; receiving an unlock request from a third client system; and transmitting unlock confirmation data to the first client system thereby causing the hidden virtual sides to be unhidden. The unlock request from the first client system comprises geolocation data, and wherein the unlock request from the third client system comprises geolocation data. The software programs further include instructions for transmitting unlock confirmation data to the third client system thereby causing the hidden virtual sides to be unhidden. The software programs further include instructions for transmitting a delete request to the first client system thereby causing the electronic trading card to be deleted from the first client system. The software programs further include instructions for receiving statistical data about the entity that is the subject of the electronic trading card; and transmitting the statistical data to the first client system, where the statistical data is associated with at least one of the plurality of virtual sides. The software programs further include instructions for transmitting the statistical data to the third client system, where the statistical data is associated with at least one of the plurality of virtual sides. The software programs further include instructions for receiving a data response from the second client system; and transmitting the data response to the first client system.

Another embodiment of the current disclosure is an electronic trading card system comprising a server system comprising memory, a processor, and one or more software programs, where the software programs are stored within the memory and are executed by the processor, and where the software programs include instructions for: storing an electronic trading card, where the electronic trading card comprises a plurality of virtual sides, a digital image, and text data, where the digital image is associated with at least one of the plurality of virtual sides, where the text data is associated with at least one of the plurality of virtual sides, where the plurality of virtual sides comprises a hidden virtual side; transmitting the electronic trading card to a first client system; transmitting the electronic trading card to a second client system; receiving geolocation data from the first client system, where the geolocation data from the first client system represents a geographic location associated with the first client system; receiving geolocation data from the second client system, where the geolocation data from the second client system represents a geographic location associated with the second client system; comparing the geographic location of the first client system with the geographic location of the second client system to determine a relative distance; transmitting unlock data to the first client system if the relative distance is below a threshold value, whereby the unlock data causes the hidden virtual side of the electronic card of the first client system to be unhidden; and transmitting unlock data to the second client system if the relative distance is below a threshold value, whereby the unlock data causes the hidden virtual side of the electronic card of the second client system to be unhidden. The software programs further include instructions for receiving a data request from the first client system; transmitting the data request to a third client system, where the third client system is associated with an entity that is a subject of the electronic trading card. The software programs further include instructions for receiving statistical data related to an entity that is a subject of the electronic trading card; and transmitting the statistical data to the first client system, where the statistical data is associated with at least one of the plurality of virtual sides of the electronic trading card. The software programs further include instructions for receiving a transfer request from the first client system; transmitting a delete request to the first client system, whereby the electronic trading card is deleted from the first client system; and transmitting the electronic trading card to a third client system;

A further embodiment of the current disclosure is an electronic trading card system comprising a server system comprising memory, a processor, and one or more software programs, where the software programs are stored within the memory and are executed by the processor, and where the software programs include instructions for: storing an electronic trading card, where the electronic trading card comprises a plurality of virtual sides, a digital image, and text data, where the digital image is associated with at least one of the plurality of virtual sides, where the text data is associated with at least one of the plurality of virtual sides, where the plurality of virtual sides comprises a hidden virtual side; transmitting the electronic trading card to a first client system; transmitting the electronic trading card to a second client system; receiving an unlock request from the first client system; transmitting the unlock request to the second client system; receiving an unlock confirmation form the second client system; and transmitting the unlock confirmation to the first client system, whereby the unlock data causes the hidden virtual side of the electronic card of the first client system to be unhidden. The software programs further include instructions for receiving a data request from the first client system; and transmitting the data request to a third client system, where the third client system is associated with an entity that is a subject of the electronic trading card. The software programs further include instructions for receiving a data response from the third client system; and transmitting the data response to the first client system. The software programs further include instructions for receiving statistical data related to an entity that is a subject of the electronic trading card; and transmitting the statistical data to the first client system, where the statistical data is associated with at least one of the plurality of virtual sides of the electronic trading card. The software programs further include instructions for receiving a transfer request from the first client system; transmitting a delete request to the first client system, whereby the electronic trading card is deleted from the first client system; and transmitting the electronic trading card to a third client system. The electronic trading card further comprises an expiration date, wherein the electronic trading card enables a client system to delete the electronic trading card from that client system on or after the expiration date. The software programs further include instructions for determining if the electronic trading card resides on a maximum number of client systems or more; and transmitting the electronic trading card to another client system if the electronic trading card resides on less than a maximum number of client systems.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF FIGURES

FIG. 1 is a flowchart showing one of the many possible interactions between a star and the older of one of her, in this case, cards.

### DETAILED DESCRIPTION OF THE INVENTION

A particular embodiment of the current invention invention is an electronic trading card that can combine the best aspects of traditional, two-sided physical trading cards, social media, data analysis and fan/star interaction. The electronic trading card is downloaded by a fan. It can be bought online, purchased or traded-for from another person, or given away by a star. There can be limited editions of the card, or the card can have limited time period before it has to be traded, or even a limited lifetime. There is also the possibility that the card could be “renewed” if the fan reaches certain milestones are reached or games won.

The card can have one or more images on it. Additional images of the star can be added to the card in the future through giveaways by the star, additional purchases, through trading, or as prizes for contests through the trading card.

The trading card allows a fan to send messages and post videos, and a star to view and selectively respond, with messages or responsive videos. More particularly, the celebrities can use the information from the fan posts to assess their current public images, and make adjustments as necessary—basically it gives the celebrities a real time picture of what their fan base thinks of them. This, in turn, will not only give the star an ongoing feedback on what image refinements are working, or not working, but will also give their commercial parties valuable information about the various celebrities' fan bases and how they can more effectively sell to them.

As with any electronic system integrated with social media, there are ample opportunities for celebrities (or commercial operations interested in capitalizing on the celebrities' fans) to increase participation through games, leveling up, and other types of interactions. These can be solitary in nature, or can require two or more fans to team up to solve a particular challenge or perform a particular goal. The celebrities can also participate in this interaction through giving rewards (such as increased contact with the star) to fans who show their fanaticism to certain great extents.

Celebrities can also use data from these interactions to better mobilize their fan bases for buying tickets to their concerts or athletic events, seeing their movies, and directing other fan behavior that the celebrities would find desirable. Third party retailers can use the same data to more accurately target advertising and promotional campaigns at the fans.

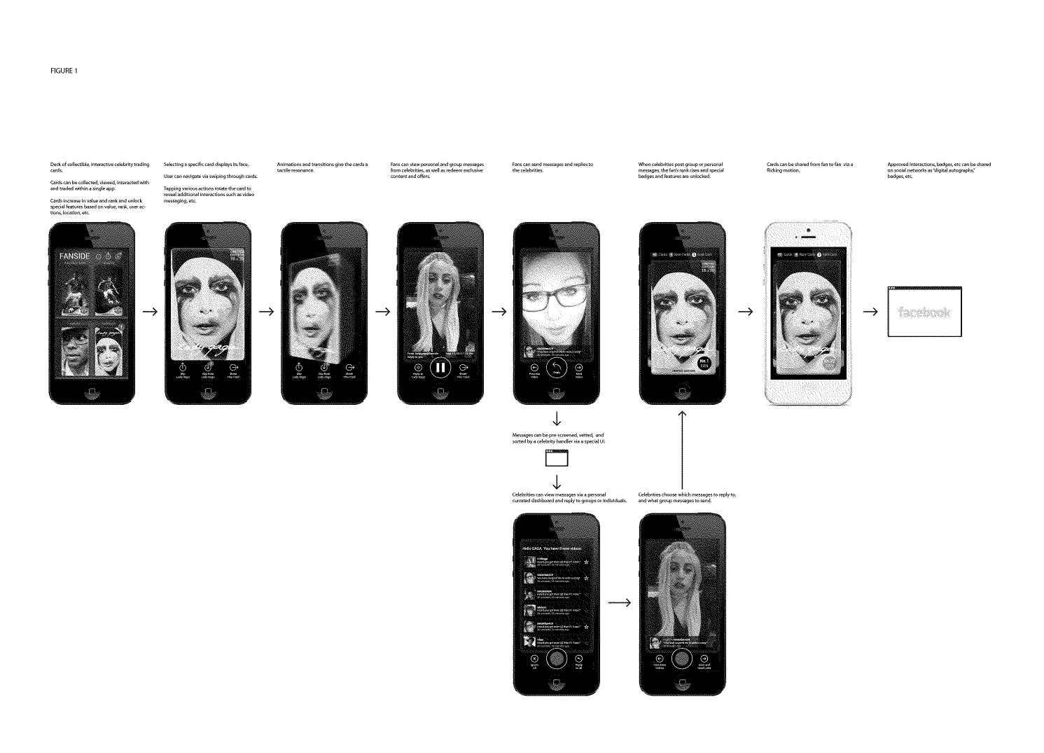

FIG. 1 illustrates just a few of the possible ways that celebrities and fans can interact. In this particular illustration, a star has a card that has a number of different “faces” or sides that the fan can obtain or earn. As described, the card can be flipped over to give it a more “tactile” or “traditional” feel. A simple tap on the card will bring up a menu with a variety of features and possible actions.

Each side of the card, or virtual side, can have one or more content types associated therewith, including without limitation digital images, text, video, and audio. The electronic trading card focuses on one or more subjects, such as the star, sports team, business, or any other individual, entity, character, or topic that a person may be interest in. Statistical data about the subject matter, such as a star's weight, heart rate, dress size, mood, or other interesting data, can be included with the electronic card, and transmitted separately and associated with the separate card to create dynamic virtual sides of the electronic trading card.

A user may also the electronic trading card to communicate with or request additional data from the subject of the trading card. For example, a user may request a “waist size” virtual side of the electronic trading card for a particular celebrity. This request can be transmitted to a server system and relayed to a client system that is associated with the celebrity. The celebrity can then choose to enter this data, and it will get transmitted back to the server system, which then in turn transmits it to the requesting client. This new data may show up in a previously generated virtual side, or a new virtual side of the electronic trading card. This customized virtual side can be available only to the user who requested the data, or it can be made available to all users who have that electronic trading card.

Users may transfer cards from their device or account to another users device or account. A trade or transfer request can be initiated by the user who currently possesses the electronic trading card (the seller) or by another user who would like to possess the electronic trading card (the buyer), but cannot otherwise (perhaps due to a limited release of the electronic trading card). If accepted by both parties, the electronic card is deleted from the seller's device, and then transmitted to the buyer's device. Depending upon the embodiment and configuration of the electronic trading card system, unhidden virtual sides or other custom virtual sides may or may not be transferred to the buyer of the electronic trading card. Monetary compensation may also be exchanged between the parties. A percentage of these funds may be retained by the operator of the electronic trading card system.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. An electronic trading card system comprising
a server system comprising memory, a processor, and one or more software programs, where the software programs are stored within the memory and are executed by the processor, and where the software programs include instructions for:
storing an electronic trading card, where the electronic trading card comprises a plurality of virtual sides, a digital image, and text data, where the digital image is associated with at least one of the plurality of virtual sides, where the text data is associated with at least one of the plurality of virtual sides;
transmitting the electronic trading card to a first client system;
receiving a data request from the first client system; and
transmitting the data request to a second client system, where the second client system is associated with an entity that is a subject of the electronic trading card.

2. The electronic trading card system of claim 1, where the electronic trading card further comprises one or more hidden virtual sides, where each of the one or more hidden virtual sides comprises digital image content, text content, or both.

3. The electronic trading card system of claim 2, wherein the software programs further include instructions for
transmitting the electronic trading card to a third client system;
receiving an unlock request from the first client system;
receiving an unlock request from a third client system; and
transmitting unlock confirmation data to the first client system thereby causing the hidden virtual sides to be unhidden.

4. The electronic trading card system of claim 3, wherein the unlock request from the first client system comprises geolocation data, and wherein the unlock request from the third client system comprises geolocation data.

5. The electronic trading card system of claim 3, wherein the software programs further include instructions for
transmitting unlock confirmation data to the third client system thereby causing the hidden virtual sides to be unhidden.

6. The electronic trading card system of claim 1, wherein the software programs further include instructions for
transmitting a delete request to the first client system thereby causing the electronic trading card to be deleted from the first client system.

7. The electronic trading card system of claim 1, wherein the software programs further include instructions for
receiving statistical data about the entity that is the subject of the electronic trading card; and
transmitting the statistical data to the first client system, where the statistical data is associated with at least one of the plurality of virtual sides.

8. The electronic trading card system of claim 7, wherein the software programs further include instructions for
transmitting the statistical data to the third client system, where the statistical data is associated with at least one of the plurality of virtual sides.

9. The electronic trading card system of claim 1, wherein the software programs further include instructions for
receiving a data response from the second client system; and
transmitting the data response to the first client system.

10. An electronic trading card system comprising
a server system comprising memory, a processor, and one or more software programs, where the software programs are stored within the memory and are executed by the processor, and where the software programs include instructions for:
storing an electronic trading card, where the electronic trading card comprises a plurality of virtual sides, a digital image, and text data, where the digital image is associated with at least one of the plurality of virtual sides, where the text data is associated with at least one of the plurality of virtual sides, where the plurality of virtual sides comprises a hidden virtual side;
transmitting the electronic trading card to a first client system;
transmitting the electronic trading card to a second client system;
receiving geolocation data from the first client system, where the geolocation data from the first client system represents a geographic location associated with the first client system;
receiving geolocation data from the second client system, where the geolocation data from the second client system represents a geographic location associated with the second client system;
comparing the geographic location of the first client system with the geographic location of the second client system to determine a relative distance;
transmitting unlock data to the first client system if the relative distance is below a threshold value, whereby the unlock data causes the hidden virtual side of the electronic card of the first client system to be unhidden; and
transmitting unlock data to the second client system if the relative distance is below a threshold value, whereby the unlock data causes the hidden virtual side of the electronic card of the second client system to be unhidden.

11. The electronic trading card system of claim 10, wherein the software programs further include instructions for
receiving a data request from the first client system;
transmitting the data request to a third client system, where the third client system is associated with an entity that is a subject of the electronic trading card.

12. The electronic trading card system of claim 10, wherein the software programs further include instructions for
receiving statistical data related to an entity that is a subject of the electronic trading card; and
transmitting the statistical data to the first client system, where the statistical data is associated with at least one of the plurality of virtual sides of the electronic trading card.

13. The electronic trading card system of claim 10, wherein the software programs further include instructions for
receiving a transfer request from the first client system;
transmitting a delete request to the first client system, whereby the electronic trading card is deleted from the first client system; and
transmitting the electronic trading card to a third client system;

14. An electronic trading card system comprising
a server system comprising memory, a processor, and one or more software programs, where the software programs are stored within the memory and are executed by the processor, and where the software programs include instructions for:
storing an electronic trading card, where the electronic trading card comprises a plurality of virtual sides, a digital image, and text data, where the digital image is associated with at least one of the plurality of virtual sides, where the text data is associated with at least one of the plurality of virtual sides, where the plurality of virtual sides comprises a hidden virtual side;
transmitting the electronic trading card to a first client system;
transmitting the electronic trading card to a second client system;
receiving an unlock request from the first client system;
transmitting the unlock request to the second client system;
receiving an unlock confirmation form the second client system; and
transmitting the unlock confirmation to the first client system, whereby the unlock data causes the hidden virtual side of the electronic card of the first client system to be unhidden.

15. The electronic trading card system of claim 14, wherein the software programs further include instructions for
receiving a data request from the first client system; and
transmitting the data request to a third client system, where the third client system is associated with an entity that is a subject of the electronic trading card.

16. The electronic trading card system of claim 15, wherein the software programs further include instructions for
receiving a data response from the third client system; and
transmitting the data response to the first client system.

17. The electronic trading card system of claim 14, wherein the software programs further include instructions for
receiving statistical data related to an entity that is a subject of the electronic trading card; and
transmitting the statistical data to the first client system, where the statistical data is associated with at least one of the plurality of virtual sides of the electronic trading card.

18. The electronic trading card system of claim 14, wherein the software programs further include instructions for
receiving a transfer request from the first client system;
transmitting a delete request to the first client system, whereby the electronic trading card is deleted from the first client system; and
transmitting the electronic trading card to a third client system.

19. The electronic trading card system of claim 14, wherein the electronic trading card further comprises an expiration date, wherein the electronic trading card enables a client system to delete the electronic trading card from that client system on or after the expiration date.

20. The electronic trading card system of claim 14, wherein the software programs further include instructions for
determining if the electronic trading card resides on a maximum number of client systems or more; and
transmitting the electronic trading card to another client system if the electronic trading card resides on less than a maximum number of client systems.
